(19) United States
(12) Patent Application Publication
(10) Pub. No.: US 2004/0264094 A1
(43) Pub. Date: Dec. 30, 2004

(54) Protective control method and apparatus for power devices

(76) Inventors: Md Azizur Rahman, St. John's (CA); Saleh Abed Al-aziz Mohammed Saleh, St. John's (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/839,376

(22) Filed: May 6, 2004

Related U.S. Application Data
(60) Provisional application No. 60/468,067, filed on May 6, 2003.

(51) Int. Cl. H02H 7/04

(52) U.S. Cl. 361/115

(57) ABSTRACT

A protective control apparatus and method is disclosed for protecting the operation of a power device upon detection of an internal fault condition. The power device has a circuit breaker for connecting the power device to a power supply. The protective control apparatus comprises a current measuring unit operatively connected to the power device for measuring currents within the power device and a protective relay processing unit connected to the current measuring unit for receiving the measured currents and connected to the circuit breaker for providing a control signal thereto. The protective relay processing unit performs a multi-resolution analysis of the measured currents preferably using Wavelet Packet Transform decomposition, to detect the internal fault condition, and upon detection of the internal fault condition, provides a control signal to disable the circuit breaker.

### CROSS-REFERENCE TO RELATED APPLICATION

This application claims the priority of provisional application Ser. No. 60/468,067 filed May 6, 2003.

### FIELD OF THE INVENTION

The invention is directed towards an apparatus and method for protecting power devices, and in particular, for detecting, isolating and preventing faults in power transformers.

### BACKGROUND OF THE INVENTION

Power transformers play a very important role in power systems, and as a result, their protection is of great importance to assure stable and reliable operation of the whole system. The major concern in power transformer protection is to avoid the false tripping of the protective relays (i.e. the circuit breaker switches) within the power transformer due to the misidentification of an internal fault current within the power transformer. For instance, it is well known to those skilled in the art that magnetizing inrush currents may have a high magnitude that is indistinguishable from typical internal fault currents. Accordingly, a trip signal must not be initiated for the protective relays during high inrush currents and through-fault conditions, but at the same time a trip signal must be quickly initiated for the protective relays to protect the power transformer against all internal fault currents.

One of the most significant distinguishing characteristics of the magnetizing inrush currents is the second harmonic, which has a higher amount of inrush current than internal fault currents or normal currents. Accordingly, many conventional transformer protection methods employ a second harmonic restraint approach to differentiate between the magnetizing inrush currents and the internal fault currents (i.e. an internal fault condition). The second harmonic restraint approach involves using different algorithms such as the Discrete Fourier Transform, the Least-Squares Method, Rectangular Transforms, Kalman Filtering Techniques, Walsh functions and Haar Functions, etc. to calculate harmonic contents. However, the second harmonic may also exist in some internal fault currents within the windings of the power transformer. In addition, the new low-loss amorphous core materials that are used in modern power transformers may produce lower second harmonic contents in the inrush current.

### SUMMARY OF THE INVENTION

The invention is directed towards a system and method for detecting, isolating and preventing internal fault currents (i.e. internal fault conditions) within a power transformer thereby protecting the power transformer. The invention involves the analysis of differential current signals from the power transformer for detecting an internal fault current and distinguishing the internal fault current from all types of inrush currents and through-fault conditions. Advantageously, the invention involves disengaging at least one switch in the circuit breaker of the power transformer only when an internal fault current is detected and not when high inrush currents or through-fault currents are detected. The detection and disengaging occurs within a very short time period. The invention uses time-frequency analysis (i.e. preferably the Wavelet Packet Transform) to distinguish between inrush currents, through-fault current conditions and internal fault currents within the power transformer.

In a first aspect, the invention is directed towards a protective control apparatus for protecting the operation of a power device upon detection of an internal fault condition. The power device has a circuit breaker, with at least one switch, for connecting the power device to a power supply. The protective control apparatus comprises: a) a current measuring unit operatively connected to the power device for measuring currents within the power device; and, b) a protective relay processing unit connected to the current measuring unit for receiving the measured currents and connected to the circuit breaker for providing at least one control signal thereto. The protective relay processing unit applies multi-resolution analysis to the measured currents to detect the internal fault condition, and upon detection of the internal fault condition, provides the at least one control signal to disable the at least one switch of the circuit breaker.

In another aspect, the invention is directed towards a method of protecting the operation of a power device upon detection of an internal fault condition. The power device has a circuit breaker with at least one switch for connecting the power device to a power supply. The method comprises:

a) measuring currents within the power device;

b) applying multi-resolution analysis to the measured currents for detecting the internal fault condition; and,

c) providing at least one control signal to the circuit breaker, wherein upon detection of the internal fault condition, at least one control signal is provided to disable the at least one switch of the circuit breaker.

### BRIEF DESCRIPTION OF THE DRAWINGS

For a better understanding of the present invention and to show more clearly how it may be carried into effect, reference will now be made, by way of example only, to the accompanying drawings which show a preferred embodiment of the present invention and in which:

FIG. 1 is a block diagram of a power transformer connected to a protective control apparatus in accordance with the present invention;

FIG. 2 is a circuit diagram of an exemplary load for the power transformer of FIG. 1;

FIG. 3 is a schematic diagram of an isolation circuit that is used in the protective control apparatus of FIG. 1;

FIG. 4 is a circuit diagram of oscillation circuits that are used in the protective control apparatus of FIG. 1;

FIG. 5 is a block diagram illustrating the decomposition of a signal using Wavelet Packet Transforms;

FIG. 6 is a flowchart of a control algorithm used by the protective control apparatus of FIG. 1;

FIG. 7 is a series of plots illustrating the operation of the power transformer and the protective control apparatus for the case of normal operating current;

FIG. 8 is a series of plots illustrating the operation of the power transformer and the protective control apparatus for the case of magnetizing inrush current at no load;

FIG. 9a is a series of plots illustrating the operation of the power transformer and the protective control apparatus for the case of primary loaded phase-to-phase fault current before energization of the power transformer;

FIG. 9b is a series of plots illustrating the operation of the power transformer and the protective control apparatus for the case of loaded secondary three-phase-to-ground fault current; and, FIG. 9c is a series of plots illustrating the operation of the power transformer and the protective control apparatus for the case of single-phase-to-ground fault current.

### DETAILED DESCRIPTION OF THE INVENTION

The inventors have realized the benefits of detecting and classifying current signatures for different types of currents within a power transformer by employing time-frequency analysis via the Wavelet Packet Transform. In particular, the protective control apparatus of the present invention is equipped with multi-resolution analysis (i.e. wavelet analysis) features to prevent tripping during all forms of inrush currents including over-excitation, current transformer (CT) saturation and mismatches for many types of power transformers including those having regular iron and amorphous laminations. The protective control apparatus utilizes a control algorithm, preferably implemented in software, that is able to quickly differentiate between through-faults and internal fault currents as well as between the inrush and internal fault currents, and is fast and reliable. Furthermore, the protective control apparatus is not dependent on the device parameters of the power transformer or the protective relay.

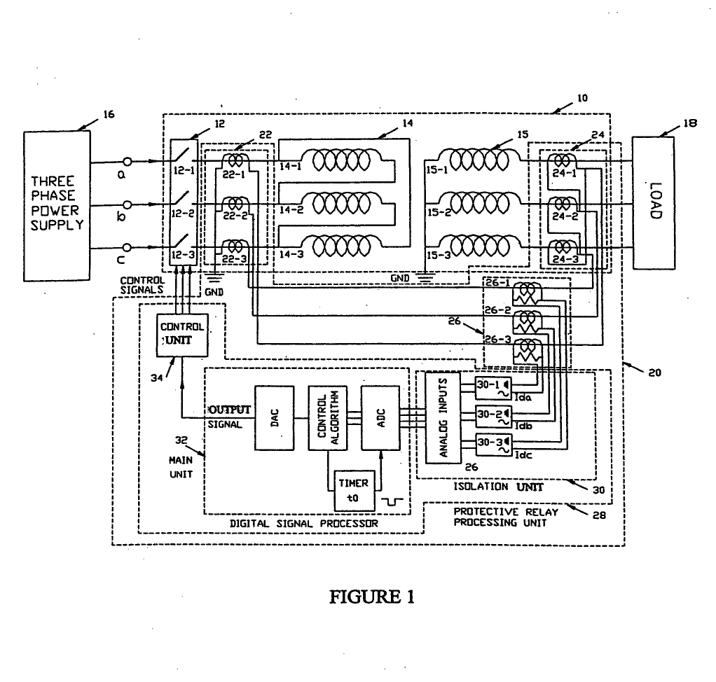

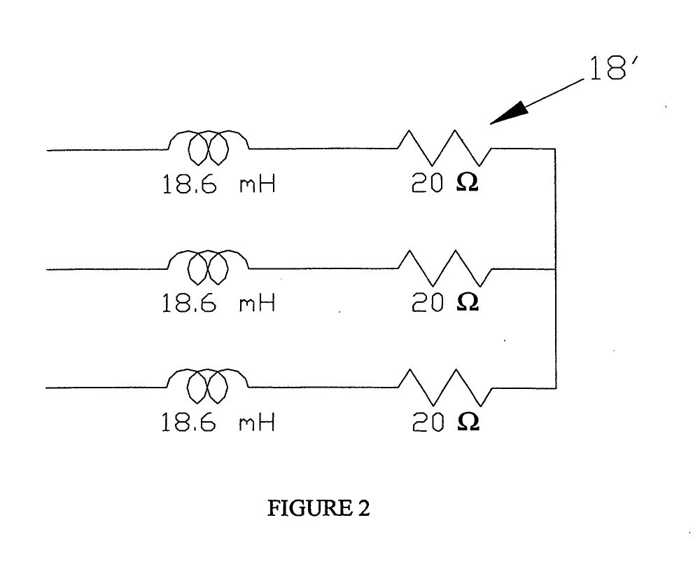

Referring now to FIG. 1, shown therein is a power transformer 10 comprising a circuit breaker 12 having three circuit breaker switches 12-1, 12-2 and 12-3. The power transformer 10 further comprises a primary 14 having primary winding coils 14-1, 14-2 and 14-3, and a secondary 15 having secondary winding coils 15-1, 15-2 and 15-3. In this case, the primary winding coils 14-1,14-2 and 14-3 are connected in a delta configuration and the secondary winding coils 15-1, 15-2 and 15-3 are connected in a Y configuration. As is well known to those skilled in the art, other configurations for the primary 14 and secondary windings 15 are possible. The power transformer 10 has input terminals a, b and c for connecting the power transformer 10 to a three-phase power supply 16. The power transformer 10 is also connected to a load 18. A sample load 18′ is given in FIG. 2 for exemplary purposes. The sample load 18′ is a balanced three-phase load in which each phase comprises an inductor and a resistor having values of 18.6 mH and 20 Ω respectively.

In use, the circuit breaker switches 12-1, 12-2 and 12-3 are closed so that the power transformer 10 can receive power from the three-phase power supply 16. When an internal fault is detected, the circuit breaker switches 12-1, 12-2 and 12-3 are opened, due to control signals, to isolate the power transformer 10 from the three-phase power supply 16 and protect the power transformer 10.

In accordance with the present invention, a protective control apparatus 20 is connected to the power transformer 10 for detecting internal fault currents and providing at least one control signal (i.e. a trip signal) to the circuit breaker 12 to open the circuit breaker switches 12-1, 12-2 and 12-3. The protective control apparatus 20 is able to distinguish internal fault currents from inrush currents, through-currents and other cases in which the circuit breaker switches 12-1, 12-2 and 12-3 of the circuit breaker 12 should not be opened.

The protective control apparatus 20 comprises a differential current measuring unit for determining the difference in current between the primary and secondary windings 14 and 15 for each of the three phases of the power transformer 10. The differential current measuring unit comprises a first current sensor 22 having three current transformer (CT) coils 22-1, 22-2 and 22-3 connected to the primary 14 of the power transformer 10, a second current sensor 24 having three CT coils 24-1, 24-2 and 24-3 connected to the secondary 15 of the power transformer 10, and a differential current sensor 26 having three CT coils 26-1, 26-2 and 26-3. Since the primary winding 14 is connected in a delta configuration, the first current sensor 22 is connected in a Y-configuration with its neutral solidly grounded. The first current sensor 22 measures the currents in the three phases of the primary winding 14. The second current sensor 24 is connected in a delta configuration, since the secondary winding 15 is connected in a Υ configuration, with its neutral solidly grounded. The second current sensor 24 measures the currents in the three phases of the secondary winding 15. Different connection configurations can be used for the first and second current sensors 22 and 24 depending on the connection configuration of the primary 14 and secondary windings 15 of the power transformer 10. The CT coils 26-1, 26-2 and 26-3 of the differential current sensor 26 measure the differential current Ida, Idb and Idc for each phase of the power transformer 10 between the primary 14 and secondary windings 15. The location of the first 22 and second current sensors 24 allows the protective control apparatus 20 to focus on the currents occurring within the power transformer 10 and to ignore any other events which are occurring outside of the power transformer 10. Other suitable current sensors may also be used.

The protective control apparatus 20 further comprises a protective relay processing unit 28 that is connected to the differential current measuring unit to receive the measured differential currents Ida, Idb and Idc. The protective relay processing unit 28 is also connected to the circuit breaker 12 to provide control signals to trip the circuit breaker switches 12-1, 12-2 and 12-3 when an internal fault current is detected within the power transformer 10. In the embodiment of FIG. 1, the protective relay processing unit 28 comprises an isolation unit 30, a main unit 32 and a control unit 34.

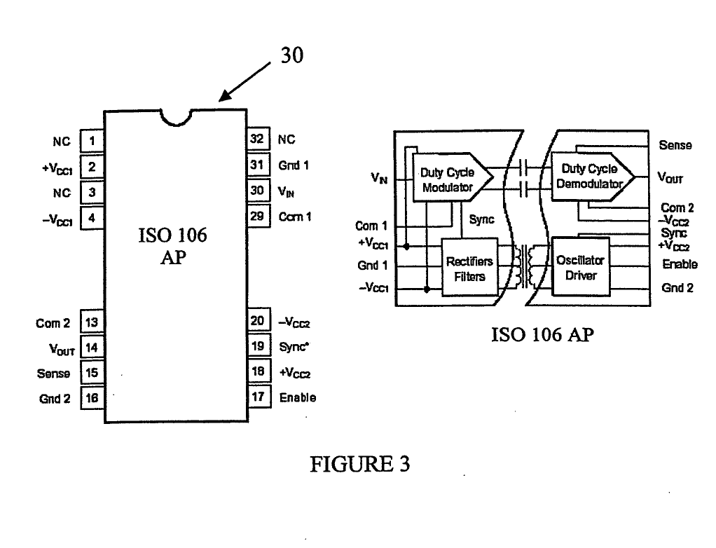

The isolation unit 30 has isolation circuits 30-1, 30-2 and 30-3 which receive the measured differential currents Ida, Idb and Idc that are provided by the differential current measuring unit. Each isolation circuit 30-1, 30-2 and 30-3 preferably comprises an isolation amplifier and associated electronic components to act as a buffer and protect the main unit 32 from dangerous currents that may be received from the power transformer 10. A particular exemplary embodiment of an isolation circuit is shown in FIG. 3. In this case, the isolation circuit is an ISO106 isolation amplifier made by Burr-Brown (other suitable oscillators may be used). The isolation circuits 30-1, 30-2 and 30-3 provide the measured differential currents as analog inputs to the main unit 32.

The main unit 32 executes the control algorithm of the protective control apparatus 20 and is preferably implemented using a digital signal processor. However, other suitable circuitry could also be used. The main unit 32 comprises an analog-to-digital converter (ADC), a digital signal processor for performing the control algorithm, a digital-to-analog converter (DAC) and a timer. The ADC receives the measured differential currents from the isolation circuits 30-1, 30-2 and 30-3 and the timer coordinates the sampling of these measurements and the timing of the control algorithm. The digital signal processor executes the control algorithm, using the measured differential currents Ida, Idb and Idc, and provides a digital output signal to the DAC which provides a corresponding analog control signal to the control unit 34. Accordingly, the digital signal processor is responsible for reading the samples of the measured differential current, executing the control algorithm and for initiating the output signal.

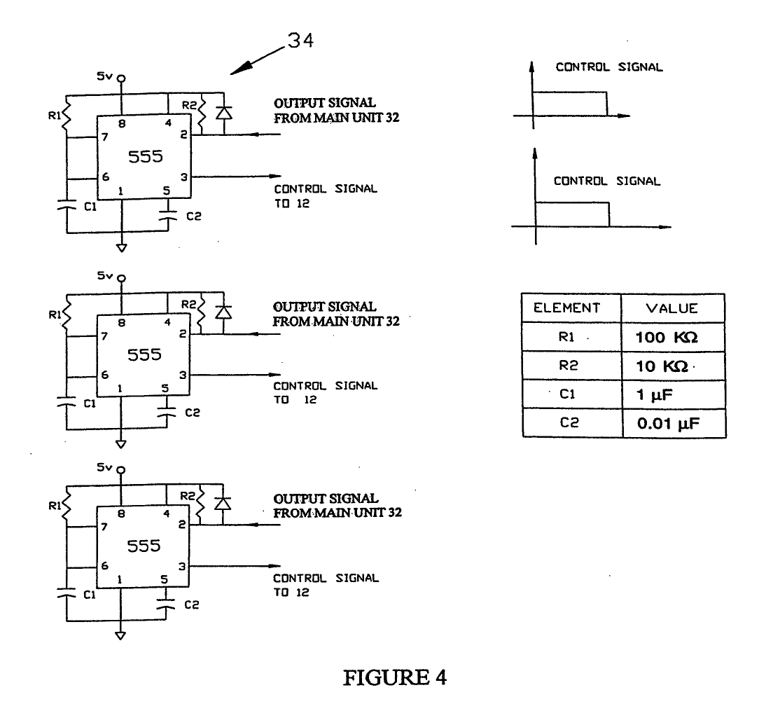

The control unit 34 is connected to the main unit 32 and the circuit breaker 12. The control unit 34 receives the output signal from the DAC and generates at least one control signal to control the operation of the circuit breaker 12. The output signal received from the DAC is preferably a binary signal having either a first value indicating that an internal fault has not been detected within the power transformer 10 or a second value indicating that an internal fault has been detected within the power transformer 10. In the first instance, the control signals generated by the control unit 34 will allow the circuit breaker switches 12-1, 12-2 and 12-3 to remain closed so that the power transformer 10 remains connected to the three-phase power supply 16. In the second instance, the control signals generated by the control unit 34 will cause the circuit breaker switches 12-1, 12-2 and 12-3 to open so that the power transformer 10 is disabled. The details of an exemplary embodiment for the control unit 34 are provided in FIG. 4. In this case, the control unit 34 comprises three 555 IC oscillators which each receive the output signal from the DAC of the main unit 32 and provide a control signal. Exemplary values for resistors and capacitors are given for controlling the width of each control signal. The control unit 34 is used to isolate the main unit 32 from the power transformer 10 for protection purposes. In addition, the control unit 34 is used to provide enough current to actuate the circuit breakers of the protective relay 12. Alternatively, the output signal and the control unit 34 can be altered to separately control each circuit breaker switch 12-1, 12-2 and 12-3 in the circuit breaker 12.

The isolation unit 30 and the control unit 34 of the protective relay processing unit 28 are needed to protect the main unit 32 from dangerous currents that may exist in the power transformer 10 (the control unit 34 also provides signals of sufficient strength to control the circuit breaker switches of the circuit breaker 12). Accordingly, there may be alternative embodiments of the protective control apparatus 20 in which one or both of the isolation unit 30 and the control unit 34 are omitted depending on the electrical parameters of the power transformer 10, the circuit breaker 12, the protective relay processing unit 28 and the processing circuitry of the main unit 32.

The control algorithm that is implemented by the main unit 32 preferably utilizes the Wavelet Packet Transform (WPT) to analyze the measured differential currents Ida, Idb and Idc to distinguish internal fault currents, in which the power transformer 10 should be disabled, from many other conditions such as inrush currents and through-fault or normal operating currents in which case the power transformer 10 should not be disabled.

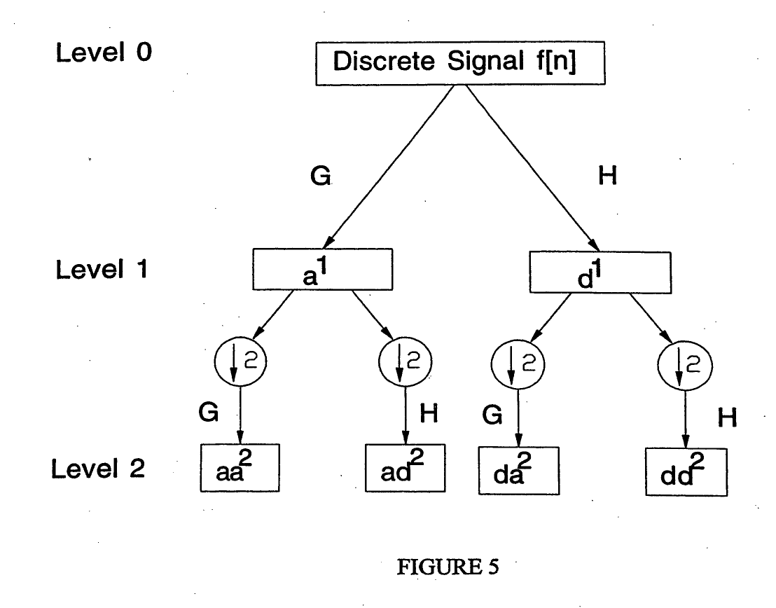

The WPT is a generalized version of the Discrete Wavelet Transform (DWT) in which each level of resolution j (also known as an octave) consists of 2^{j} boxes corresponding to low-pass and high-pass filter operations. The frequency bandwidth of a box decreases with increasing octave number (i.e. the frequency resolution becomes higher, while the time resolution is reduced). Starting with a signal f[n] with length N, the first level decomposition will produce two sub-bands, which are the details a¹[N/2] and approximations d¹[N/2] of the signal f[n], as would any other wavelet transform. The second level of decomposition will produce four sub-bands due to the decomposition of both a¹[N/2] and d^{1[N/}2] using the same set of filters that were used in the first level of decomposition. These four sub-bands are aa²[N/4], ad²[N/4], da²[N/4] and dd²[N/4]. The two levels of wavelet decomposition can be represented in a binary tree format as shown in FIG. 5. Advantageously, the WPT provides a more accurate and detailed representation of the decomposed signals compared to other Wavelet Packet Transforms. Also, the wavelet packet transform employs basis functions, which are localized in time thereby offering a better signal approximation, accurate time localization and precise decomposition. Other Wavelet Packet Transforms will lead to an increase in execution time, and accordingly may be used if the processing speed of the main unit 32 is fast enough to provide control signals to trip the circuit breaker 12 in an acceptable amount of time.

The basis functions are generated from one base function (also known as a Mother wavelet) at a scale s, an oscillation c and a location b according to:

w_{s,c,b}(n)=2^{j/2}W_{c}(2^{-j}(n−b)) (1)

where W_{c}(n) is the base function associated with the mother wavelet. The mother wavelet is preferably selected using the Minimum Description Length (MDL) criterion for determining the optimum mother wavelet having a minimal amount of entropy. The inventors have found that such a mother wavelet provides a high degree of accuracy and decomposition in the Wavelet Packet Transform and minimizes the levels of decomposition that are needed to distinguish internal fault currents from inrush and through-fault or normal currents. The optimal mother wavelet is preferably the Daubechies mother wavelet. Other mother wavelets will result in an increase in the required number of decompositions, which in turn will increase the execution time.

In wavelet packet analysis, the signal f[n] is represented as a sum of orthogonal wavelet packet basis functions w_{s,c,b}(n) at different scales s, oscillations c and locations b according to:

$$f [ n ] = {\sum }_{s} {\sum }_{c} {\sum }_{b} {w}_{s , c , b} {W}_{c} [ n ] \qquad ( 2 )$$

The WPT has a decomposition tree as shown in FIG. 5. The WPT employs the Discrete Wavelet Transform (DWT) to implement the general decomposition process. The labels G and H in FIG. 5 stand for low pass and high pass filters, respectively, associated with a selected mother wavelet. For example, one possible example of the coefficients for the filters G and H that can be used are:

H₈[n]=[−0.23, 0.72, −0.63, 0.03, 0.19, 0.03, −0.03, −0.01] (3)

G₈[n]=[−0.01, 0.03, 0.03, −0.19, −0.03, 0.63, 0.72, 0.23] (4)

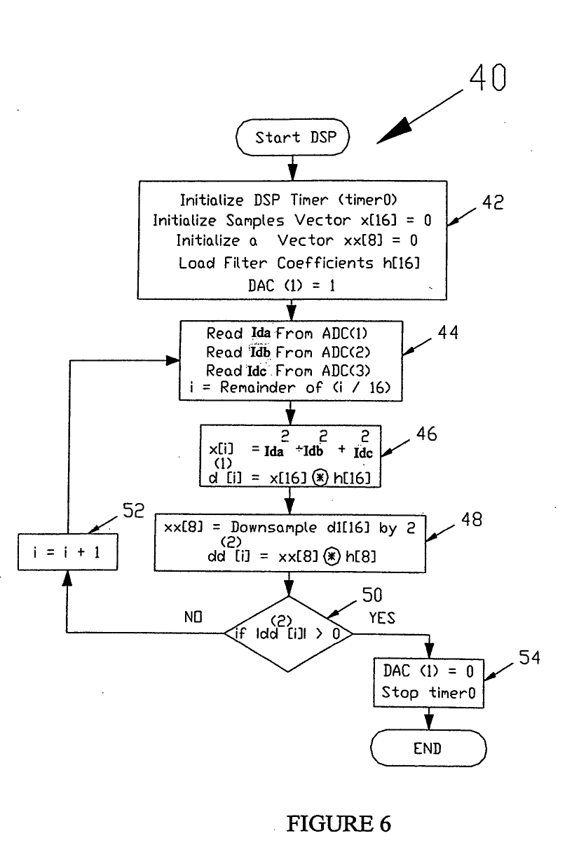

Referring now to FIG. 6, shown therein is a flowchart of a control algorithm 40 that is executed by the main unit 32 of the protective relay processing unit 28. The control algorithm 40 begins at step 42 in which the timer of the main unit 32 is initialized and the variables x (the sampled measured differential currents), h (the filter coefficients of the high pass filter), d (i.e. d⁽¹⁾—the detail of the filtered sampled measured differential currents at the first level of wavelet decomposition), xx (the downsampled version of d) and dd (i.e. dd⁽²⁾—the details of the filtered sampled measured differential currents at the second level of wavelet decomposition) are initialized. At step 42, a mother wavelet can be chosen to provide the filter coefficients for the vector h. The minimum description length criteria, or some other type of optimization algorithm, may be used to select an appropriate mother wavelet. In addition, the output signal from the DAC is initialized to 1 (i.e. the circuit breakers switches 12-1, 12-2 12-3 of the circuit breaker 12 should not be tripped). The variables x, xx, d and dd are vectors.

At step 44, the sampled measured differential currents are read and the index i is updated. The index i is related to the current sample of the measured differential current. In this example, the index i is cycled between 1 and 16. The sampling frequency is set to 10 kHz to satisfy both the requirements of the downsampling and conditions of Nyquist criterion.

At step 46 of the control algorithm 40, the value of the sampled measured differential current vector x is updated with the sum of the squares of the measured differential currents for each phase of the power transformer 10. The squared summed differential current is then filtered according to the filter coefficients defined in the vector h to provide the detail d of the first level of resolution (i.e. first level of wavelet decomposition). The circular convolution operation (e.g. a 16-sample circular convolution), as is commonly known to those skilled in the art, is preferably used to implement this filtering operation. The operations performed in step 44 simplify the detection of fault currents within the power transformer 10 by combining the differential currents from each phase. This is beneficial in reducing the computational complexity of the control algorithm 40 since the wavelet filter h is applied to one data vector rather than to three data vectors (i.e. one for each phase). Accordingly, when an internal fault current is detected by the control algorithm 40, each circuit breaker switch of the circuit breaker 12 is opened. Alternatively, the wavelet filter h can be applied to three separate data vectors, each representing one of the differential phase currents of the power transformer 10, to detect which phase of the power transformer 10 has an internal fault.

At step 48 of the control algorithm 40, the detail d of the first level of wavelet decomposition (i.e. first level of resolution) is downsampled by a factor of two, stored in the vector xx and then filtered again by the high-pass wavelet filter used to provide the detail dd of the second level of wavelet decomposition (i.e. second level of resolution). At step 50 of the control algorithm 40, the magnitude of the second level of detail dd at the current index i is obtained and compared to a threshold value. The second level of detail dd represents the frequency components in the upper octave of the measured differential currents. The inventors have found that in this frequency range, an internal fault current can be distinguished from other types of currents including inrush currents and normal currents by applying a threshold value of 0. This comparison is done on a sample-by-sample basis (i.e. for the current index i) to quickly determine when an internal fault current occurs within the power transformer 10 and to reduce the computational complexity of the control algorithm 40. Alternatively, the entire vector dd representing the details of the second level of decomposition may be examined in step 50. If the comparison in step 50 is false, then the index i is incremented by 1 and the circuit breaker switches 12-1, 12-2 and 12-3 of the circuit breaker 12 are left in the closed position. However, if the comparison in step 50 is true, then an output value of 0 is provided by the DAC at step 54. The control unit 34 then provides control signals that will trip the switches of the circuit breaker 12 to isolate the power transformer 10 from the three-phase power supply 16.

The inventors have found that using wavelet analysis of the measured differential currents allows for the localization of specified frequency components to be determined at particular instants of time. This is important since current transients corresponding to fault currents within the power transformer 10 are of short duration, non-periodic and of a high frequency nature. These current transients may have signal components in the second, third and fourth, or even higher levels of detail (i.e. resolution) of the wavelet decomposition. Accordingly, the control algorithm 40 comprises at least two levels of wavelet decomposition. Higher levels of wavelet decomposition can be used for more complex power devices, or for certain types of mother wavelets. The inventors have found that the control algorithm 40 can detect and trip the power transformer 10 within 2 to 3 ms (less than a quarter cycle based on 60 Hz supply frequency) after the beginning of an internal fault condition.

Experiments have been done to determine the performance of the protective control apparatus 20. The experimental results and the parameters used for the protective control apparatus 20 are shown for illustrative purposes and are not meant to limit the invention. In the experiments, a laboratory three-phase 5 kVA, 230/550-575-600 V, 60 Hz, Δ-Y core type power transformer was used. The setup used for the experiment was in accordance with the block diagram of FIG. 1. Several cases involving different types of currents were investigated including: 1) normal operating current, 2) magnetizing inrush current at no load, and 3) fault currents including three-phase, line-to-line and single-line-to-ground faults. The control algorithm 40 utilized the Daubechies (db4) mother wavelet with two levels of resolution. Three identical current transformers were connected in a Y configuration on the primary side of the power transformer, and three identical current transformers were connected in a delta configuration on the secondary side of the power transformer. The differential current entering the differential current sensor was measured throughout the experiment. Three identical TRIAC switches were used to make a connection between the power transformer and the three-phase power supply for a certain period of time. The current was sampled at a frequency of 10 kHz.

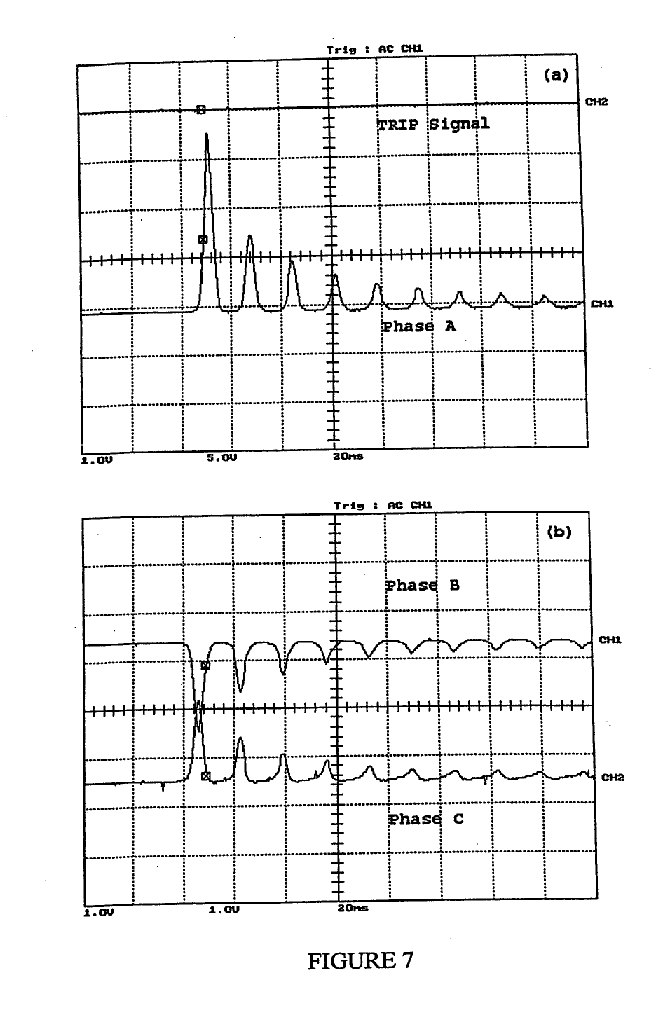

In the first case (i.e. the normal current case), the differential current was collected when the power transformer was loaded with a 3-phase balanced Y resistive load of 20Ω/phase and connected at a primary line voltage of 130 V. FIG. 7 shows the three-phase differential currents. The trip signal (i.e. the output of block 54 of the control algorithm 40) remains high indicating that the protective control apparatus 20 has not detected a fault, and hence the circuit breaker 12 has not disconnected the transformer 10 from the three-phase power supply 16.

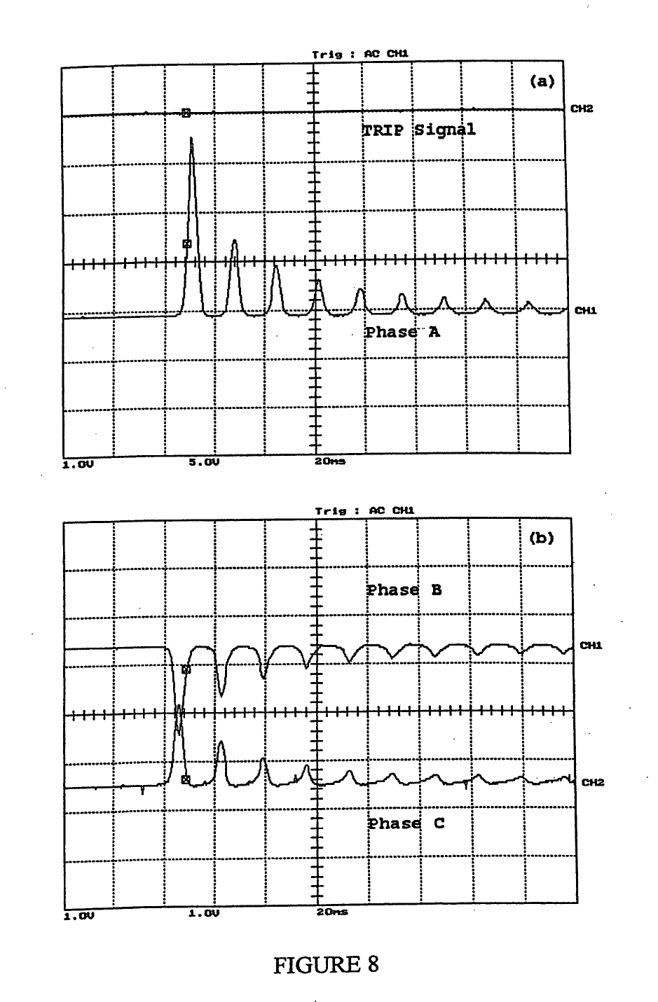

In the second case (i.e. magnetizing inrush current at no load), the current was allowed to flow for about a 10 cycle time period (based on a 60 Hz system) and the power transformer was connected at a primary line voltage of 130 V, without any load. FIG. 8 shows the three-phase differential currents. The trip signal remains high indicating that the protective control apparatus 20 has not detected a fault, and hence the circuit breaker 12 has not disconnected the transformer 10 from the three-phase power supply 16.

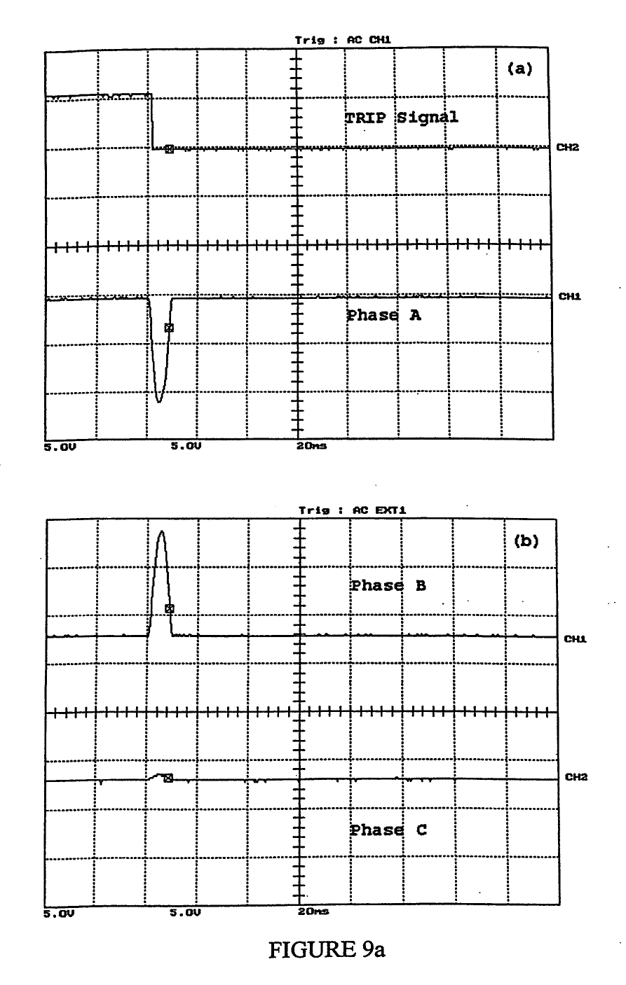

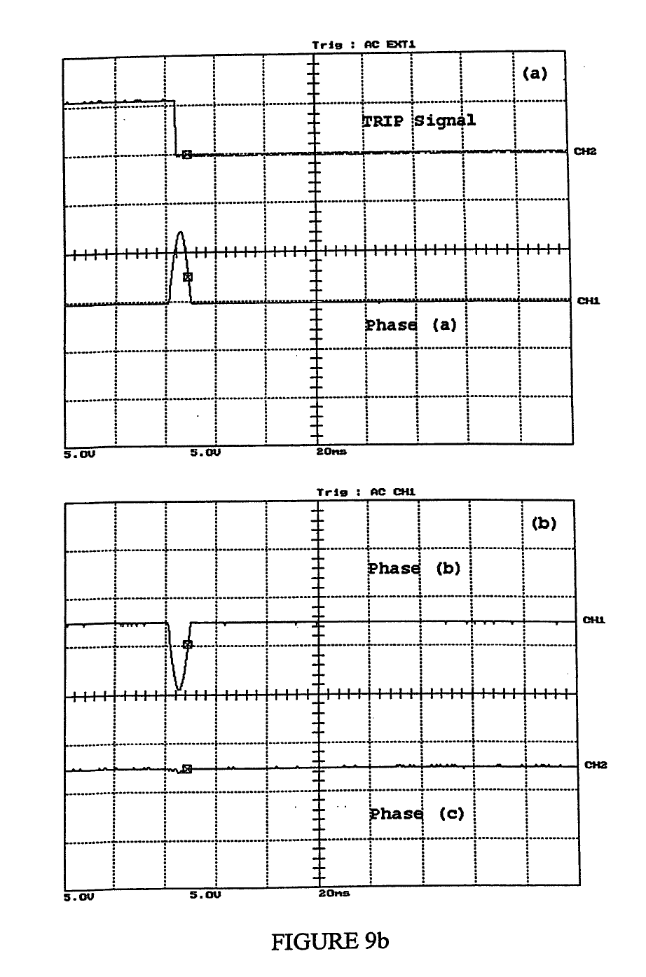

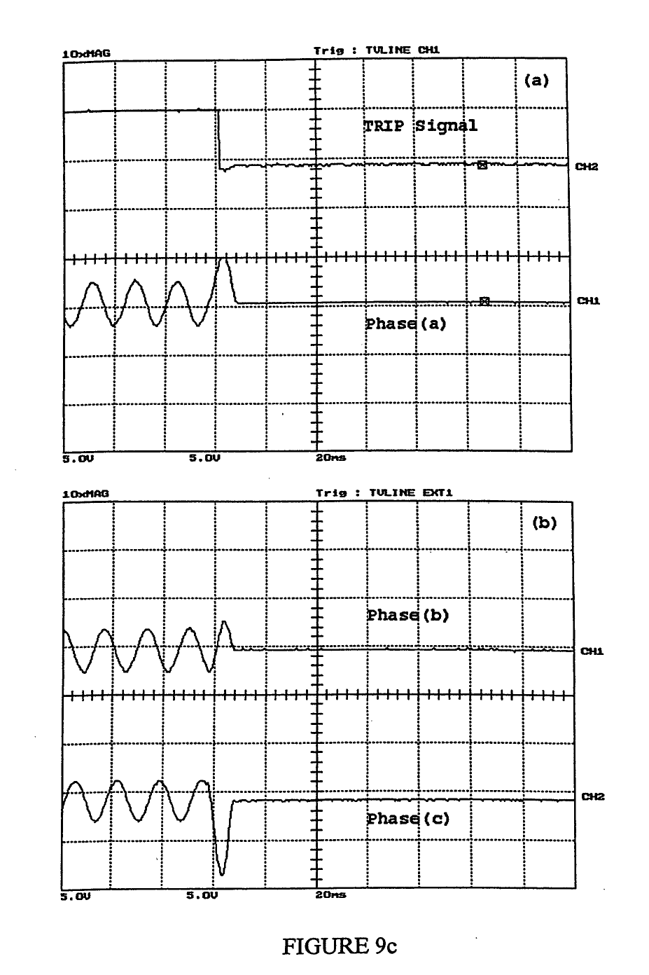

In the first part of the third case (i.e. a primary line-to-line fault current at load), a line-to-line fault exists in phases a-b in the power transformer. The 3-phase load of the first case was connected to the power transformer. FIG. 9a shows the differential currents for phases a, b and c. In this case, the trip signal status has changed from high to low indicating that the protective control apparatus 20 has detected a fault, and hence the circuit breaker 12 has disconnected the transformer 10 from the three-phase power supply 16.

In the second part of the third case (i.e. a secondary three-phase to ground fault current at load), a three-phase fault has occurred before energizing the power transformer with the same three-phase load used in the first case. The primary line-to-line voltage was set at 50 V to avoid saturation and/or damage of the equipment during the testing. FIG. 9b shows the differential currents for phases a, b and c. The status of the trip signal has changed from high to low indicating that the protective control apparatus 20 has detected a fault, and hence the circuit breaker 12 has disconnected the transformer 10 from the three-phase power supply 16.

In the last part of the third case (i.e. a secondary single phase to ground fault current at load), the fault took place after energizing the transformer with same load (as in case 1) connected to the secondary side of the power transformer. FIG. 9c shows the differential currents for phases a, b and c. The status of the trip signal (i.e. control signal) has changed from high to low indicating that the protective control apparatus 20 has detected a fault, and hence the circuit breaker 12 has disconnected the transformer 10 from the three-phase power supply 16.

In each of these three cases, the fault current is distinguished from the other types of current conditions. In addition, the trip signal status is changed in less than a quarter of a cycle (based on 60 Hz systems) to disconnect the power transformer from the power supply in the cases in which an internal fault was detected.

The protective control apparatus of the invention will allow for the development of very high-speed protective relays that are selective, reliable, simple and cost effective. The control algorithm of the invention is not sensitive to the device parameters of the power transformer. On the other hand, the existing transformer relays are mostly slow electromechanical types, which are based on 2nd harmonic restraint principles and sensitive to device parameters. Unlike existing protective relays, the control procedures of the invention can be software based which will facilitate its wide spread application in many types of power devices and systems. Furthermore, the protective control apparatus will not cause the circuit breakers in the protective relay to trip upon the identification of at least one of inrush and through-fault conditions thereby preventing unnecessary interruption of current flow to the power transformer in these conditions.

The protective control apparatus can also protect the power transformers made of iron and amorphous core laminations from other abnormal conditions including over current, over excitation voltage, CT saturation, neutral-to-ground circuit faults, external faults outside of the device (through-faults), CT mismatched ratio errors and tap changes, which may occur both independently and simultaneously.

Apart from the transformer differential protective relay applications, the invention is also suitable for power quality monitoring, diagnostics, alarms, protections, corrections, metering and improvements.

It should be understood that various modifications can be made to the preferred embodiments described and illustrated herein, without departing from the present invention, the scope of which is defined in the appended claims.

1. A protective control apparatus for protecting the operation of a power device upon detection of an internal fault condition, the power device having a circuit breaker with at least one switch for connecting the power device to a power supply, the protective control apparatus comprising:
a) a current measuring unit operatively connected to the power device for measuring currents within the power device; and,
b) a protective relay processing unit connected to the current measuring unit for receiving the measured currents and connected to the circuit breaker for providing at least one control signal thereto, wherein the protective relay processing unit performs a multi-resolution analysis of the measured currents to detect the internal fault condition, and upon detection of the internal fault condition, provides the at least one control signal to disable the at least one switch of the circuit breaker.

2. The protective control apparatus of claim 1, wherein the multi-resolution analysis comprises wavelet decomposition.

3. The protective control apparatus of claim 2, wherein the wavelet decomposition comprises at least two levels of wavelet packet transform decomposition.

4. The protective control apparatus of claim 2, wherein the protective relay processing unit comprises:
a) an isolation unit connected to the current measuring unit;
b) a main unit connected to the isolation unit for performing the wavelet analysis and generating an output signal; and,
c) a control unit connected to the main unit and the circuit breaker, for receiving the output signal and generating the at least one control signal,
wherein, the isolation unit and the control unit isolate the protective relay processing unit from the power device.

5. The protective control apparatus of claim 2, wherein the power device has a primary and a secondary and the current measuring unit is a differential current measuring unit for measuring the differential of currents in the primary and the secondary of the power device.

6. A method of protecting the operation of a power device upon detection of an internal fault condition, the power device having a circuit breaker with at least one switch for connecting the power device to a power supply, the method comprising:
a) measuring currents within the power device;
b) applying multi-resolution analysis to the measured currents for detecting the internal fault condition; and,
c) providing at least one control signal to the circuit breaker, wherein upon detection of the internal fault condition, the at least one control signal is provided to disable the at least one switch of the circuit breaker.

7. The method of claim 6, wherein the multi-resolution analysis comprises wavelet analysis.

8. The method of claim 7, wherein the wavelet analysis comprises at least two levels of wavelet packet transform decomposition.
